(19) United States
(12) Patent Application Publication
(10) Pub. No.: US 2005/0270578 A1
(43) Pub. Date: Dec. 8, 2005

(54) Print device featuring a fixed storage device

(75) Inventor: Charles Morton, Leander, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/862,978

(22) Filed: Jun. 8, 2004

(51) Int. Cl. G06F 13/00

(52) U.S. Cl. 358/1.16

(57) ABSTRACT

A print device includes a removable storage device and also includes a fixed storage device coupled to the removable storage device. The storage device further includes a print engine operable to be coupled to the removable storage device and the fixed storage device.

### BACKGROUND

The description herein relates generally to print devices, and more particularly to print devices featuring a storage device.

As the value and use of information continue to increase, individuals and businesses seek additional ways to process and store information. One option available to users is information handling systems. An information handling system (“IHS”) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some conventional print devices include removable storage devices that store, information (e.g., pictures and documents), which the print devices are capable of printing. With such print devices, an amount of user information that can be stored by the removable storage device is limited by the removable storage devices' storage capacities.

What is needed is a technique without the disadvantage discussed above.

### SUMMARY

Accordingly, a print device including a removable storage device is disclosed. The print device also includes a fixed storage device operable to be coupled to the removable storage device. The storage device further includes a print engine operable to be coupled to the removable storage device and the fixed storage device.

A method of operating a print device that includes a print engine, a removable storage device, and a fixed storage device coupled to the removable storage device, is also disclosed. The method includes storing, on the fixed storage device, information stored by the removable storage device.

### BRIEF DESCRIPTION OF THE DRAWINGS

FIG. 1 is a block diagram of an information handling system (“IHS”) according to an illustrative embodiment.

FIG. 2 is a more detailed block diagram of a print device of FIG. 1, according to a first embodiment.

FIG. 3 is a more detailed block diagram of a print device of FIG. 1, according to a second embodiment.

FIG. 4 is a more detailed block diagram of a print device of FIG. 1, according to a third embodiment.

FIG. 5 is a more detailed block diagram of a peripheral device of FIG. 4.

FIG. 6 is a flow chart illustrating operations performed by a user in association with a print device.

### DETAILED DESCRIPTION

As the value and use of information continues to increase, individuals and businesses seek additional ways to process and store information. One option available to users is an information handling system (“IHS”). An IHS generally processes, compiles, stores, and/or communicates information or data for business, personal, or other purposes thereby allowing users to take advantage of the value of the information. Because technology and information handling needs and requirements vary between different users or applications, IHS's often vary regarding what information is handled, how the information is handled, how much information is processed, stored, or communicated, and how quickly and efficiently the information may be processed, stored, or communicated. Such variations in IHS's allow for IHS's to be general or configured for a specific user or specific use such as financial transaction processing, airline reservations, enterprise data storage, or global communications. In addition, IHS's include a variety of hardware and software components that are for processing, storing, and communicating information. Also, IHS's often include one or more computer systems, data storage systems, and networking systems.

For purposes of this disclosure, an IHS includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. Example of an IHS include, personal computer (“PC”), a network storage device, personal digital assistant, or any other suitable device with variations in size, shape, performance, functionality, and price. An IHS also includes other components such as, random access memory (“RAM”), one or more processing resources (e.g., central processing unit (“CPU”)), hardware or software control logic, read only memory (“ROM”), other types of memory, one or more disk drives, one or more network interfaces, one or more input/output devices and/or one or more buses.

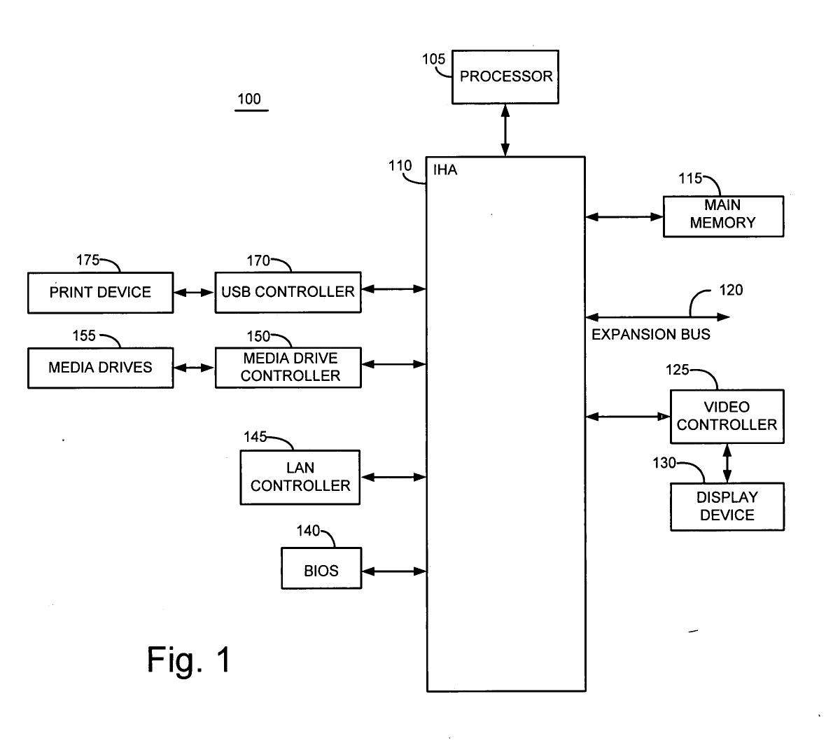

FIG. 1 is a block diagram of an IHS indicated generally at 100, according to the illustrative embodiment. The IHS 100 includes a processor 105 (e.g., an Intel Pentium series processor). An Intel Hub Architecture (IHA) chipset 110 provides the IHS 100 with graphics/memory controller hub functions and I/O functions. More specifically, the IHA chipset 110 acts as a host controller which communicates with a video controller 125 coupled thereto. A display device 130 is coupled to the video controller 125.

The chipset 110 further acts as a controller for main memory 115 which is coupled thereto. The chipset 110 also acts as an input/output (“I/O”) controller hub (ICH) which performs I/O functions. A USB controller 170 is coupled to chipset 110 so that devices such as a print device 175 can be connected to the chipset 110 and the processor 105. Examples of the print device 175 include ink jet printers, laser printers, dot matrix printers, and other devices capable of printing information on a medium (e.g., paper or transparency). Although the print device 175 communicates with the IHS 100 via a USB interface in the illustrative embodiment, in other embodiments, the print device 175 communicates with the IHS 100 via another type of interface such as serial, parallel, FireWire, and/or any other suitable connection interface. A system basic input-output system (“BIOS”) 140 is coupled to chipset 110 as shown. The BIOS 140 is stored in CMOS or FLASH memory so that it is nonvolatile.

A local area network (LAN) controller 145, alternatively called a network interface controller (NIC), is coupled to the chipset 110 to facilitate connection of the IHS 100 to other IHSs. A media driver controller 150 is coupled to chipset 110 so that devices such as media drives 155 can be connected to the chipset 110 and the processor 105. Examples of the media devices 155 capable of being coupled to the media controller 150 include CD-ROM drives, DVD drives, hard disk drives and other fixed or removable media drives. An expansion bus 120, such as a PCI bus, PCI Express bus, serial advanced technology attachment (SATA) bus or other bus is coupled to the chipset 110 as shown. The expansion bus 120 includes one or more expansion slots (not shown) for receiving expansion cards which provide the IHS 100 with additional functionality.

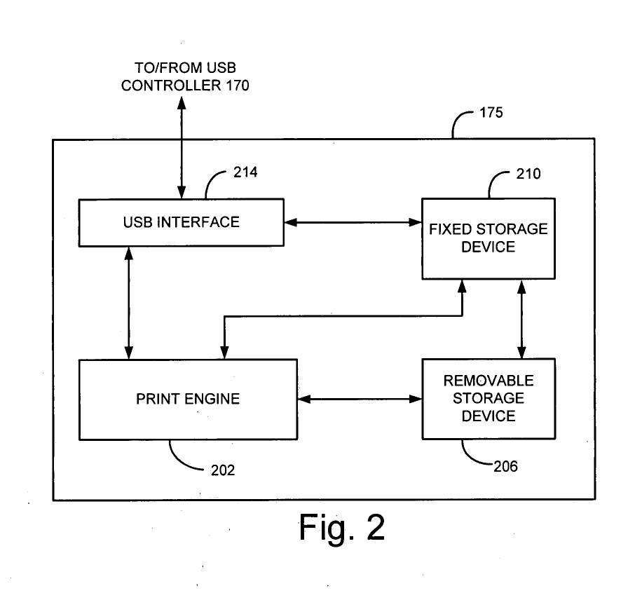

FIG. 2 is a more detailed block diagram of the print device 175 according to a first embodiment. As discussed above, examples of the print device 175 include various types of printers such as laser printers, ink jet printers (e.g., liquid ink jet printers or solid ink jet printers), dye sublimation printers, thermal wax printers, dot matrix printers and any other type of printers capable of printing on a printable medium such as a paper or transparency.

The print device 175 includes a print engine 202. The print engine 202 includes one or more apparatuses for performing the print operation of the print device 175. Accordingly, for each of the printer types discussed above, the apparatuses included by the print engine 202 vary. In one example, for a liquid ink jet printer, the print engine 202 includes apparatuses such as a print head and one or more ink cartridges for delivering ink on to a surface of a paper. In another example, for a laser printer, the print engine 202 includes apparatuses such as a toner, laser unit, a photoreceptor drum, and a fuser for using electrostatic charges to print on a printable medium.

The print device 175 also includes a USB interface 214 coupled to the print engine 214 for coupling the print device 175 to the USB controller 170 of the IHS 100. Via the USB interface 214, the print device 175 communicates with (e.g., outputs information to and receives information from) the IHS 100. Accordingly, the print device 175 is capable of printing information received from the IHS 100.

Moreover, the print device 175 includes a removable storage device 206, which is coupled to the print engine 206. Examples of the removable storage device 206 include a Compact Flash card device (Compact Flash is a trademark of the Compact Flash Association), a Smart Media card device (SmartMedia is a trademark of Toshiba Corp.), a Memory Stick device (Memory Stick is a trademark of Sony Corp.), a MultiMediaCard (“MMC”) device (MultiMediaCard is a trademark of Infineon Technologies AG), and any other storage device that is capable of reading information from and/or storing information to a suitable removable storage medium. For each of the removable storage devices discussed above as examples, removable storage device 206 includes the device's respective removable storage medium.

Referring again to FIG. 2, the print device 175 includes a fixed storage device 210 coupled to the USB interface 214 and the removable storage device 206. Examples of the fixed storage device 210 include a mass storage device such as a hard disk drive, optical storage device, and any other storage device which includes a storage medium that is generally unsuitable for removal from the storage device in its operation. In another embodiment, storage device 210 is a device that is removable from the IHS with some level of effort by the user.

On the fixed storage device 210, a user is capable of storing information such as pictures and text documents. In one example, the user is capable of transferring files from the removable storage device 206 to the fixed storage device 210, and vice versa. Accordingly, the print device 175 is operable by the user to store, on the fixed storage device 210, information that is stored by the removable storage device 206. The print device 175 is also operable to store, on the removable storage device 206, information that is stored by the fixed storage device 210.

Also, on the fixed storage device 210, the print device 175 is operable by the user to store information received from the IHS 100. Moreover, the print device 175 is operable to output information stored by the fixed storage device 210 to the IHS 100.

Although, the print device 175 is capable of operating while coupled to the IHS 100, the print device 175 is also capable of operating while not coupled to the IHS 100. For example, while operating independently of the IHS 100, the print device 175 is operable to print information stored by the fixed storage device 210 and/or the removable storage device 206.

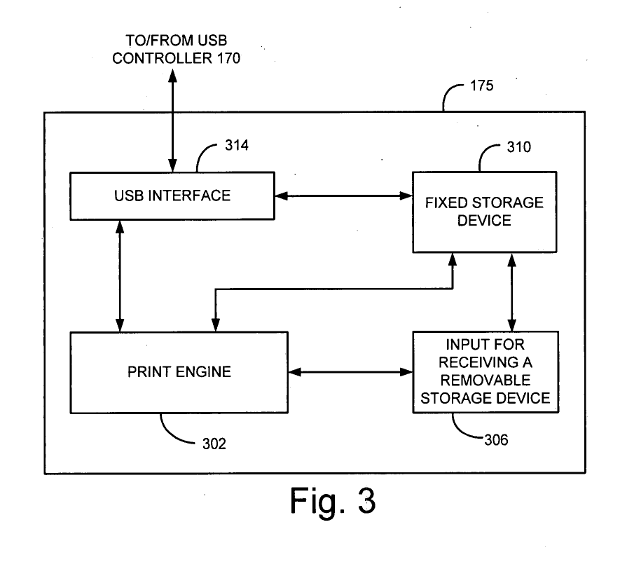

FIG. 3 is a more detailed block diagram if a print device of FIG. 1, according to a second embodiment. In this embodiment, the print device 175 includes a print engine 302, a fixed storage device 310, and a USB interface 314, each of which is respectively similar to the print engine 202, the fixed storage device 210, and the USB interface 210 of FIG. 2. The print device 175 also includes an input 306, coupled to the print engine 302 and the fixed storage device 310, adapted to receive a removable storage device.

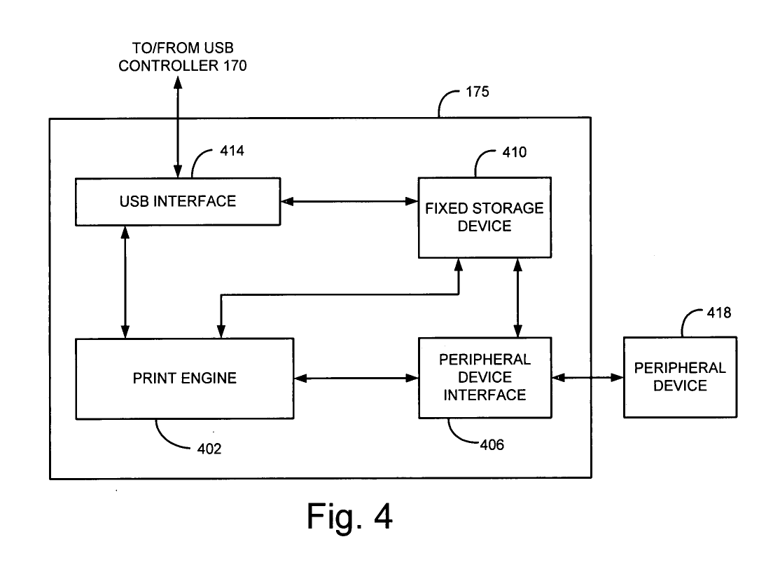

FIG. 4 is a more detailed block diagram of the print device 175 according to a third embodiment. In this embodiment, the print device 175 includes a print engine 402, a fixed storage device 410, and a USB interface 414, each of which is respectively similar to the print engine 202, the fixed storage device 210, and the USB interface 210 of FIG. 2. The print device 175 also includes a peripheral device interface 406 for coupling a peripheral device 418 (e.g., a camera) to the print device 175.

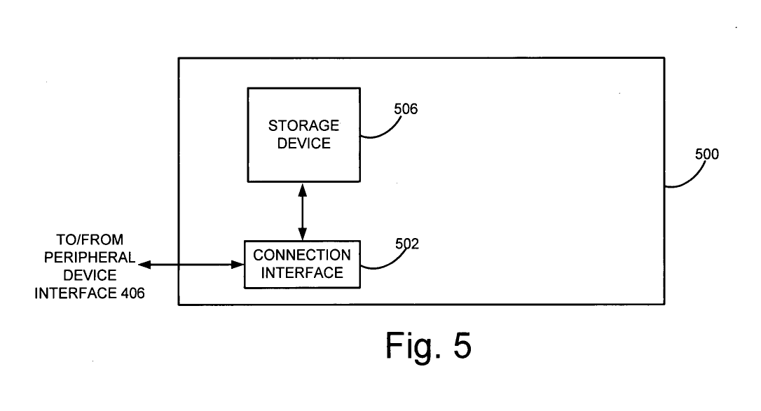

FIG. 5 is a more detailed block diagram of an example of the peripheral device 418. As shown in FIG. 5, the example of the peripheral device 418 is a camera (e.g., a digital camera) 500. The camera 500 includes a connection interface 502 for coupling the camera 500 to the print device 175 of FIG. 4. In this embodiment, the camera 500 and the print device 175 communicate with each other according to the PictBridge standard, although in other embodiments, the camera 500 and the print device 175 communicate with each other according to one or more other suitable standards.

The camera 500 also includes a storage device 506. The storage device is a fixed storage device (e.g., a fixed storage device that is substantially similar to the fixed storage device 210 of FIG. 2) or a removable storage device (e.g., a removable storage device that is substantially similar to the removable storage device 206 of FIG. 2).

Referring again to FIG. 4, on the fixed storage device 410, a user is capable of storing information (e.g., information that is stored by the storage device 506 of the camera 500) received from the peripheral device 418. Accordingly, on the fixed storage device 410, the print device 175 is operable to store the information received from the peripheral device 418. Also, the print device 175 is operable to output, to the peripheral device 418, information stored by the fixed storage device 410.

In at least one embodiment, the print device 175 of FIG. 1 includes one or more features shown in both FIG. 2 and FIG. 4. For example, in a version of such embodiment, the print device 175 of FIG. 2 includes a peripheral device interface (e.g., the peripheral device interface 406 of FIG. 4).

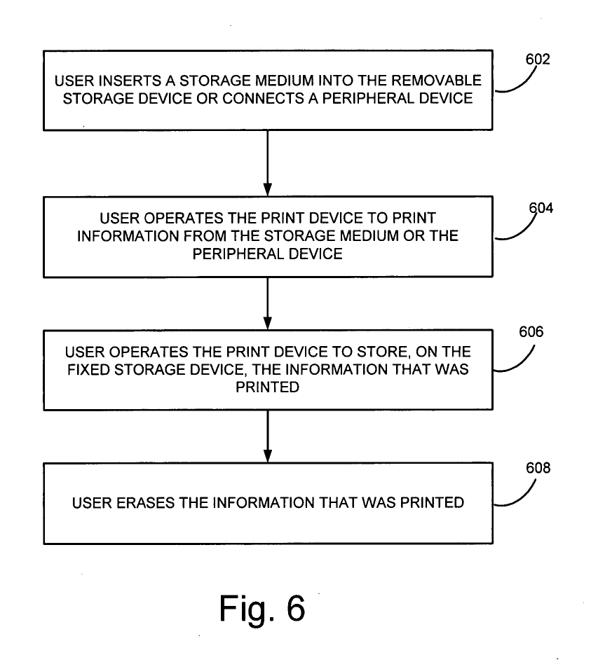

FIG. 6 is a flow chart illustrating operations performed by a user in association with the print device 175 of FIG. 1. The operation begins at a step 602, where the user inserts a storage medium into the removable a storage device (e.g., the removable storage device 206) or connects a peripheral device 418 to the print device 175. After the step 602, the operation continues to a step 604.

At the step 604, the user operates the print device 175 so that the print device 175 prints information directly from the storage medium or the peripheral device 418. After the step 604, the operation continues to a step 606.

At the step 606, the user operates the print device 175 so that, on the fixed storage device 210, the fixed storage device 310, or the fixed storage device 410, the print device 175 stores the information that was printed in the step 604. After the step 606, the operation continues to a step 608.

At the step 608, the user erases from the removable medium or the peripheral device 418 (or a storage device of the peripheral device 418), the information that was printed at the step 604. However, because the print device 175 stored the information on the fixed storage device 210, the fixed storage device 310, or the storage device 410 as discussed above, the user is still able to access the information later.

Although illustrative embodiments have been shown and described, a wide range of modification, change and substitution is contemplated in the foregoing disclosure. Also, in some instances, some features of the embodiments may be employed without a corresponding use of other features. Accordingly, it is appropriate that the appended claims be constructed broadly and in manner consistent with the scope of the embodiments disclosed herein.

1. A print device comprising:
a removable storage device;
a fixed storage device operable to be coupled to the removable storage device; and
a print engine operable to be coupled to the removable storage device and the fixed storage device.

2. The print device of claim 1, wherein the print device stores, on the fixed storage device, information stored by the removable storage device.

3. The print device of claim 1, wherein the print device stores, on the removable storage device, information stored by the fixed storage device.

4. The print device of claim 1, wherein the print device stores, on the fixed storage device, information received from an information handling system (“IHS”) coupled to the print device.

5. The print device of claim 1, wherein the print device outputs, to an information handling system (“IHS”) coupled to the print device, information stored by the fixed storage device.

6. The print device of claim 1, wherein the print device prints information stored by the fixed storage device.

7. The print device of claim 1, wherein the fixed storage device is a hard disk drive.

8. The print device of claim 1, and comprising:
an interface that is operable to couple a peripheral device to the print device.

9. A print device comprising:
a print engine;
a fixed storage device coupled to the print engine; and
an input adapted to receive a removable storage device, the input operable to be coupled to the fixed storage device.

10. The print device of claim 9, wherein the print device stores, on the fixed storage device, information stored by the removable storage device.

11. The print device of claim 9, wherein the print device stores, on the removable storage device, information stored by the fixed storage device.

12. The print device of claim 9, wherein the print device stores, on the fixed storage device, information received from an information handling system (“IHS”) coupled to the print device.

13. The print device of claim 9, wherein the print device outputs, to an information handling system (“IHS”) coupled to the print device, information stored by the fixed storage device.

14. A print device comprising:
a print engine;
an interface that couples a peripheral device to the print device; and
a fixed storage device coupled to the interface.

15. The print device of claim 14, wherein the print device stores, on the fixed storage device, information received from the peripheral device.

16. The print device of claim 14, wherein the print device outputs, to the peripheral device, information stored by the fixed storage device.

17. The print device of claim 14, wherein the peripheral device is a camera.

18. A method of operating a print device including a print engine, a removable storage device, and a fixed storage device coupled to the removable storage device, the method comprising:
storing, on the fixed storage device, information stored by the removable storage device.

19. The method of claim 18, and comprising:
storing, on the removable storage device, information stored by the fixed storage device.

20. A method of operating a print device including a print engine, an interface that couples a peripheral device to the print device, and a fixed storage device coupled to the interface, the method comprising:
storing, on the fixed storage device, information received from the peripheral device.

21. The method of claim 20, and comprising:
outputting, to the peripheral device, information stored by the fixed storage device.

22. The method of claim 20, wherein the peripheral device is a camera.

23. An information handling system (IHS) comprising:
a print device;
a controller coupling the print device to the IHS;
a print engine in the print device coupled to a fixed storage and a removable storage; and
an interface coupling the controller, the fixed storage and the print engine.
